(19) United States
(12) Patent Application Publication
(10) Pub. No.: US 2006/0197814 A1
(43) Pub. Date: Sep. 7, 2006

(54) Inkjet ink, inkjet ink set, inkjet ink tank, inkjet recording method, and inkjet recording apparatus

(75) Inventor: Takatsugu Doi, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/190,483

(22) Filed: Jul. 27, 2005

(30) Foreign Application Priority Data
Mar. 2, 2005 (JP) 2005-57938

(51) Int. Cl. G01D 11/00; C09D 11/02

(52) U.S. Cl. 347/100; 106/31.89; 106/31.75; 106/31.78

(57) ABSTRACT

An inkjet ink containing at least a pigment, a water-soluble solvent, at least two types of surfactant, and water, wherein: (I) at least one type of nonionic surfactant, and at least one of an anionic surfactant and/or an amphoteric surfactant are contained as the surfactants; (II) the nonionic surfactant has a weight-average molecular weight of 1000 or less and an SP value of 9.2 to 13, and the total number of carbon atoms and oxygen atoms in a unit constituting a hydrophilic group portion is 10 or more in the nonionic surfactant; and (III) the at least one of an anionic surfactant and/or an amphoteric surfactant has a weight-average molecular weight of from 175 to 1500.

### CROSS-REFERENCE TO RELATED APPLICATION

This application claims priority under 35 USC 119 from Japanese Patent Application No. 2005-057938, the disclosure of which is incorporated by reference herein.

### BACKGROUND OF THE INVENTION

1. Field of the Invention

The present invention relates to an inkjet ink, an inkjet ink set, an inkjet ink tank, an inkjet recording method, and an inkjet recording apparatus.

2. Description of the Related Art

An inkjet system wherein ink is ejected from ink ejecting ports composed of nozzles, slits, porous films or the like is applied to a variety of printers because of being compact and inexpensive. Among inkjet systems, a piezo inkjet system wherein ink is ejected by utilizing deformation of a piezoelectric element, and a thermal inkjet system wherein ink is ejected by utilizing boiling phenomenon of the ink by means of thermal energy have excellent characteristics of high resolution and high-speed printability.

Conventionally, an inkjet ink to which a surfactant is added has been proposed for a purpose of obtaining a picture image having a high quality and high density (for example, see Japanese Patent Application Laid-Open (JP-A) No. 63-183855). In this manner, however, there are cases where a high-temperature storage stability may be insufficient due to a combination of a colorant and a surfactant when the colorant is a pigment and the surfactant is a nonionic surfactant.

In recent years, one of important problems in inkjet printers is in realization of a high speed and high quality when using plain papers. Toward the realization, there is provided a picture image forming method wherein a liquid containing a compound having a cationic group is applied on a recording medium, thereafter the liquid permeates into the recording medium to exist therein and disappears on the surface of the medium, and at the time immediately after the disappearance of the liquid, an ink containing an anionic dye is applied onto the medium to form a picture image (for example, see Japanese Patent No. 2667401). In this manner, however, there is such a case that the density of the resulting picture image becomes insufficient when a drying time for the ink is reduced, or such a case that a long-term jetting performance is insufficient when printing is made with a small drop amount.

According to the conventional methods, bleeding, intercolor bleeding, drying time, and high-temperature storage stability could not be satisfied at the same time as described above.

### SUMMARY OF THE INVENTION

The inkjet ink of the present invention includes at least a pigment, a water-soluble solvent, at least two types of surfactant, and water wherein:

(I) at least one type of nonionic surfactant, and at least one of an anionic surfactant and/or an amphoteric surfactant are contained as the surfactants;

(II) the nonionic surfactant has a weight-average molecular weight of 1000 or less and an SP value of 9.2 to 13, and the total number of carbon atoms and oxygen atoms in a unit constituting a hydrophilic group portion is 10 or more in the nonionic surfactant; and

(III) the at least one of an anionic surfactant and/or an amphoteric surfactant has a weight-average molecular weight of from 175 to 1500.

In the inkjet ink of the invention, it is preferable that the anionic surfactant is selected from the group consisting of dialkylsulfosuccinic acids, alkenylsuccinic acids, alkenylsulfosuccinic acids, polyoxyalkylenealkyl ether phosphates, polyoxyalkylenealkyl ether sulfates, and derivatives thereof; and the amphoteric surfactant is selected from the group consisting of betaine type surfactants (e.g. amide propyl betaine type surfactants, sulfo betaine type surfactants), amideamine oxide type surfactants, imidazoline type surfactants, alanine type surfactants, and derivatives thereof.

In the inkjet ink of the invention, it is preferable that the ink has a ζ potential of −60 mV to −10 mV.

In the inkjet ink of the invention, it is preferable that the mass ratio of the addition amount of the nonionic surfactant to the addition amount of the at least one of an anionic surfactant and/or an amphoteric surfactant is within a range of from 1:0.01 to 1:0.75.

In the inkjet ink of the invention, it is preferable that in the nonionic surfactant, the total number of carbon atoms and oxygen atoms in the unit constituting the hydrophilic group portion is 70 or less.

In the inkjet ink of the invention, it is preferable that the clouding point in an aqueous solution of the nonionic surfactant is from 30° C. to 90° C.

Furthermore, an inkjet ink set of the invention comprises the inkjet ink of the invention; and a treating liquid containing at least a flocculant.

In the inkjet ink set of the invention, it is preferable that the inkjet ink further comprises a surfactant having a weight-average molecular weight of 2000 or more as the surfactant.

In the inkjet ink set of the invention, it is preferable that the treating liquid further comprise at least one colorant selected from the group consisting of dyes, pigments having a sulfonic acid or a sulfonate on the surface thereof, and self-dispersible pigments.

Moreover, an inkjet ink tank of the invention comprises the inkjet ink of the invention or the inkjet ink set of the invention stored therein.

Still further, an inkjet recording method comprises ejecting the inkjet ink of the invention or the ink and treating liquid of the inkjet ink set of the invention onto a recording medium to form a picture image.

In the inkjet recording method of the invention, it is preferable that the ink and the treating liquid are ejected onto the recording medium so as to be in contact with each other to form the picture image in case of using the inkjet ink set.

In the inkjet recording method of the invention, it is preferable that the ink and the treating liquid are ejected onto the recording medium in an amount of 25 ng or less per one drop in case of using the inkjet ink set.

In the inkjet recording method of the invention, it is preferable that the ink and the treating liquid are ejected onto the recording medium with a mass ratio of from 1:10 to 10:1 in case of using the inkjet ink set.

In the inkjet recording method of the invention, it is preferable that an ink supplied from an inkjet ink tank storing the inkjet ink or an ink and treating liquid supplied from an inkjet ink tank storing the inkjet ink set are ejected onto the recording medium.

Furthermore, an inkjet recording apparatus of the invention comprises a recording head for ejecting the inkjet ink of the invention or the ink and treating liquid of the inkjet ink set of the invention onto a recording medium.

In the inkjet recording apparatus of the invention, it is preferable that the ink and the treating liquid are ejected onto the recording medium so as to be in contact with each other in case of using the inkjet ink set.

In the inkjet recording apparatus of the invention, it is preferable that the ink and the treating liquid are ejected onto the recording medium in an amount of 25 ng or less per one drop in case of using the inkjet ink set.

In the inkjet recording apparatus of the invention, it is preferable that the ink and the treating liquid are ejected on the recording medium with a mass ratio of from 1:10 to 10:1 in case of using the inkjet ink set.

Inkjet recording apparatus of the invention preferably further comprises an inkjet ink tank for storing the inkjet ink or the inkjet ink set as well as for supplying the stored liquid to the recording head.

According to the invention, an inkjet ink and an inkjet ink set, which are excellent in a high-temperature storage stability, can be provided. Besides, an inkjet ink tank, an inkjet recording method, and an inkjet recording apparatus, which use these inkjet ink and inkjet ink set, can be provided.

### BRIEF DESCRIPTION OF THE DRAWINGS

FIG. 1 is a perspective view showing an external appearance of a preferred embodiment of an inkjet recording apparatus according to the present invention;

FIG. 2 is a perspective view showing key structures of the interior of the inkjet recording apparatus of FIG. 1;

FIG. 3 is a perspective view showing an external appearance of another preferred embodiment of the inkjet recording apparatus according to the invention;

FIG. 4 is a perspective view showing key structures of the interior of the inkjet recording apparatus of FIG. 3; and

FIGS. 5A and 5B are schematic views showing printed patterns used in evaluations conducted in examples, respectively.

### DETAILED DESCRIPTION OF THE INVENTION

In the following, the present invention will be explained in detail.

(Inkjet Ink, Inkjet Ink Set)

The inkjet ink (hereinafter, simply referred to as “ink” optionally) according to the invention includes at least a pigment, a water-soluble solvent, at least two types of surfactant, and water wherein: (I) at least one type of nonionic surfactant, and at least one of an anionic surfactant and/or an amphoteric surfactant are contained as the surfactants; (II) the nonionic surfactant has a weight-average molecular weight of 1000 or less and an SP value of 9.2 to 13, and the total number of carbon atoms and oxygen atoms in a unit constituting a hydrophilic group portion is 10 or more in the nonionic surfactant; and (III) the at least one of an anionic surfactant and/or an amphoteric surfactant has a weight-average molecular weight of from 175 to 1500.

In general, the permeability of an inkjet ink on a recording medium is controlled by adjusting the surface tension of the inkjet ink. For this purpose, surfactants and the like are principally used, and particularly, nonionic surfactants and the like are used. A nonionic surfactant having a high hydrophobic property has the effect of increasing permeability, but has low solubility in water, often lowering the reliability of the resulting ink. On the other hand, it is known that although a nonionic surfactant having a high hydrophilic property has improved solubility in water thus increasing the reliability of the resulting ink, its permeability tends to decrease, so that the drying time of the ink increases.

Furthermore, it has become clear that when a surfactant having appropriately balanced hydrophilic-hydrophobic properties is used as a surfactant which can realize both the reliability and the permeability of the ink, there arises the disadvantage that the pigment flocculates during storage of the ink at a high temperature. While the cause of this is not clear, the following two causes are presumed.

A) In general, it is known that a hydrophilic/hydrophobic balance of nonionic surfactants correlates to a clouding point. In this respect, there is a tendency for a clouding point to become higher than room temperature in the above-mentioned surfactant that achieves reliability together with permeability of the resulting ink.

Accordingly, when an ink containing such a surfactant is heated at a temperature equal to or higher than a clouding point of the surfactant, the surfactant becomes insoluble or forms a micelle structure, whereby an area appears where a concentration of the surfactant locally increases. As a result, a pigment flocculates at a site where a concentration of the pigment increases, so that the high-temperature storage stability of the ink deteriorates.

B) A nonionic surfactant usually exhibits a moderate affinity with a surface of a pigment. Accordingly, when the probability of associations of a pigment with a surfactant in an ink increases during high temperature storage, a crosslinking action occurs among the pigment particles, whereby the pigment is flocculated, and the high-temperature storage stability of the ink decreases.

As a result of intensive research in this respect, it has been found that the high-temperature storage stability can be improved in addition to improvements of the reliability and permeability of an ink by providing an inkjet ink with the configuration described above. While the mechanism thereof is not clear, it may be presumed as described herebelow.

Namely, when at least one kind of anionic surfactant or amphoteric surfactant is added into a nonionic surfactant aqueous solution, there is a tendency for either the clouding point of the nonionic surfactant to become high, or to become indeterminable. This is because of the following, for example. In a nonionic surfactant aqueous solution heated to a temperature not less than the clouding point, a plurality of surfactant molecules assemble to form a micelle wherein hydrophobic group portions are directed inwards and hydrophilic group portions are directed outwards. On the other hand, the anionic surfactant is adsorbed to hydrophobic group portions of the nonionic surfactant, whereby the nonionic surfactant is dissolved, because of the existence of an anionic surfactant or an amphoteric surfactant. Thus, the resulting ink does not exceed the clouding point of the nonionic surfactant even in high-temperature storage, resulting in suppression of pigment flocculation, whereby it becomes possible to improve high-temperature storage stability. As described above, a combination of anionic surfactants and nonionic surfactants is important.

Moreover, it is also important that the SP value of a nonionic surfactant is 9.2 to 13, preferably 9.5 to 12.5, and more preferably 10.0 to 12.0. When the SP value of the nonionic surfactant is less than 9.2, solubility in water decreases, and the storage stability of an ink decreases. On the other hand, when the SP value of the nonionic surfactant exceeds 13, the permeability of the ink decreases, so that sufficient dryness cannot be obtained. The SP value is calculated in accordance with the Fedors method.

It is required that the total number of carbon atoms and oxygen atoms in a unit constituting a hydrophilic group portion of a nonionic surfactant is 10 or more, preferably 10 to 70, and more preferably 15 to 45. When the total number of carbon atoms and oxygen atoms in the hydrophilic group portion unit is less than 10, the surface active performance decreases. In this case, it is necessary to increase the amount of surfactant added in order to obtain a sufficient permeability of an ink, which leads to a decrease in the storage stability of the ink. When the total number of carbon atoms and oxygen atoms in the hydrophilic group portion unit exceeds 70, there are cases where the high-temperature storage stability of the resulting ink decreases. This phenomenon arises presumably because the probability of associations of pigments and surfactants increases during high-temperature storage, whereby crosslinking takes place among the pigments.

It is also important that the weight-average molecular weight of an anionic surfactant and an amphoteric surfactant is 175 to 1500, preferably 175 to 1000, and more preferably 200 to 800. When the molecular weight is less than 175, an advantageous effect of raising the clouding point of the nonionic surfactant does not function and the high-temperature storage stability of the ink is not improved, while when the molecular weight exceeds 1500, the solubility of the anionic surfactant and the amphoteric surfactant decreases, so that the storage stability of the resulting ink decreases.

In addition, it is preferred that the hydrophobic portion of a nonionic surfactant has as high an affinity as possible with that of an anionic surfactant or an amphoteric surfactant. Further, an anionic surfactant and an amphoteric surfactant also have the function of acting as electrolytes to decrease the electrostatic repulsive force among pigments in addition to the effect of being adsorbed to the surfaces of the pigments to improve the dispersion stability of the pigments.

On the other hand, the sizes of the molecules in a surfactant are important for decreasing the crosslinking effect of the nonionic surfactant at high temperature. In this respect, it has been found that high-temperature storage stability can be improved by restricting the weight-average molecular weight of the nonionic surfactant to 1000 or less. The weight-average molecular weight is preferably 100 to 1000, and more preferably 200 to 750.

In addition, it is also preferable that the total number of carbon atoms and oxygen atoms constituting hydrophilic group portions in the nonionic surfactant is less than 70, as it has become clear that a highly advantageous effect can be attained by this restriction. This is presumably because the surfactant takes a micelle structure in an ink, and the extension of molecular chains of the surfactant in the ink depends on the hydrophilic group chain length. More specifically, it is thought that when the molecular chain length of a hydrophilic group portion is extended, the extension of the molecular chain increases, whereby the crosslinking action among pigments is increased.

Meanwhile, while an inkjet ink of the invention may be used alone, it may also be used for an inkjet ink set in which the ink is used together with a treating liquid containing a flocculant. When an inkjet ink is used as an inkjet ink set, the ink and the treating liquid may be ejected onto a recording medium such that they are in contact with each other, whereby it becomes possible to improve the optical density. This is because of the following. When they are contact with each other on the recording medium, a pigment aggregate is generated by aggregation of pigments and, moreover, the pigment aggregate is separated from the solvent. When the ink and the treating liquid are arranged such that the pigment aggregate grows sufficiently with respect to voids in recording medium fibers, it becomes possible to retain the pigment aggregate on a surface of the recording medium at a high density, whereby the optical density thereof can be increased. On the other hand, when the pigment aggregate is separated from the solvent, it becomes possible to suppress extension of the pigments in the surface direction of the recording medium, whereby bleeding and intercolor bleeding are improved. At the same time, it becomes possible to improve the drying time because only the separated solvent permeates into the recording medium.

When an inkjet ink of the invention is used as an ink set as described above, it is desired that a surfactant having a weight-average molecular weight of 2000 or more is allowed to be further contained in the ink in order to form a pigment aggregate having a sufficient size at the time when the ink contacts with a treating liquid. This may be because of the following. It is thought that the pigment and the surfactant form a crosslinking structure, whereby it becomes possible to form a pigment aggregate having a sufficient size. For this purpose, a surfactant having a weight-average molecular weight of 2000 or more, which has a hydrophilic-hydrophobic balance close to that of the surfaces of the pigments is required. Moreover, to form a crosslinking structure, it is important to consider the size of the molecular structure of the surfactants. In this respect, a weight-average molecular weight of the surfactant is preferably 2000 or more, more preferably 3500 or more, and still further preferably 4000 or more, but the upper limit thereof may be 500,000. When the weight-average molecular weight is less than 2000, formation of the aggregate is insufficient, whereby there are cases where sufficient optical density cannot be obtained.

As described above, the balance between the pigments, the nonionic surfactant, and the anionic surfactant or amphoteric surfactant in the ink is important. The same is true in the case of an ink set wherein the ink is used together with a treating liquid, whereby picture quality, ink reliability, dryness, and high-temperature storage stability are simultaneously achieved. Since an inkjet ink of the invention is constituted so as to have the above-described conditions and requirements, the resulting inkjet ink can exhibit improved high-temperature storage stability, and can achieve satisfactory properties with respect to bleeding, intercolor bleeding, drying time, and high-temperature storage stability at the same time.

In the following, the inkjet ink according to the invention will be explained in more detail. The inkjet ink of the invention contains a pigment, a water-soluble solvent, at least two types of surfactants, and water. In the case where the inkjet ink of the invention is used as an inkjet ink set, in which a treating liquid is used together, it is desired that at least three types of surfactants are contained as mentioned above.

First, pigments as colorants will be explained. Both of organic pigments and inorganic pigments may be used as colorants. As black pigments, there are carbon black pigments such as furnace black, lamp black, acetylene black, and channel black.

Specific color pigments such as red, green, blue, brown, and white pigments; and metallic luster pigments such as gold, and silver color pigments may also be used in addition to black color, and three primary colors of cyan, magenta, and yellow pigments. Moreover, such pigments that are newly synthesized may be used for the invention.

A specific example of pigments includes (trade name): RAVEN 7000, RAVEN 5750, RAVEN 5250, RAVEN 5000 ULTRA II, RAVEN 3500, RAVEN 2000, RAVEN 1500, RAVEN 1250, RAVEN 1200, RAVEN 1190 ULTRA II, RAVEN 1170, RAVEN 1255, RAVEN 1080, and RAVEN 1060 (all these are manufactured by Columbia Carbon Corporation); (trade name): REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300, and MONARCH 1400 (all these are manufactured by Cabs Corporation); and (trade name): COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX35, PRINTEX U, PRINTEX V, PRINTEX140U, PRINTEX140V, SPECIAL BLACK 6, SPECIAL BLACK 5, SPECIAL BLACK 4A, and SPECIAL BLACK 4 (manufactured by Degussa Corporation); and (trade name): NO. 25, NO. 33, NO. 40, NO. 47, NO. 52, NO. 900, NO. 2300, MCF-88, MA600, MA7, MA8, and MA100 (all these are manufactured by Mitsubishi Chemical Corporation). However, the invention is not restricted to those enumerated above.

An example of cyan color pigments includes C.I. Pigment Blue-1, -2, -3, -15, -15:1, -15:2, -15:3, -15:4, -16, -22, -60, and the like, but it is to be noted that the invention is not limited to those described above.

An example of magenta color pigments includes C.I. Pigment Red-5, -7, -12, -48, -48:1, -57, -112, -122, -123, -146, -168, -184, -202, and the like, but it is to be noted that the invention is not limited to those described above.

An example of yellow color pigments includes C.I. Pigment Yellow-1, -2, -3, -12, -13, -14, -16, -17, -73, -74, -75, -83, -93, -95, -97, -98, -114, -128, -129, -138, -151, -154, -155, -180 and the like, but it is to be noted that the invention is not limited to those described above.

Pigments self-dispersible in water may also be used in the invention. The self-dispersible pigment means a pigment which has a number of water-soluble groups on a surface of the pigment and which is stably dispersed in water in the absence of a polymer dispersant. More specifically, when a surface modification treatment such as an acid-basic treatment, a coupling agent treatment, a polymer graft treatment, a plasma treatment, and oxidation/reduction treatment is applied to a usual so-called pigment, a pigment self-dispersible in water can be obtained.

Other than that obtained by applying a surface modification treatment to pigments as described above, a commercially available self-dispersible pigment such as (trade name): CAB-O-JET-200, CAB-O-JET-250, CAB-O-JET-260, CAB-O-JET-270, CAB-O-JET-300, IJX-444, and IJX-55 (manufactured by Cabs Corporation); and (trade name): MICROJET BLACK CW-1, CW-2 (manufactured by Orient Chemical Industries, Ltd) and the like may also be used as a self-dispersible pigment in water.

In addition, a pigment covered with a resin may be used as a pigment to be used in the invention. Such pigment is called microcapsule pigment, and pre-production microcapsule pigments for the invention may be used in addition to commercially available microcapsule pigments manufactured by Dainippon Ink and Chemicals Inc., Toyo Ink Mfg. co., Ltd. and the like.

A pigment is used within a range of from 0.1% by mass to 50% by mass with respect to the total mass of the ink, and preferably 1% by mass to 10% by mass. When the amount of the pigment is less than 0.1%, there are cases where sufficient optical density cannot be achieved, while when the amount of the pigment is more than 50% by mass, there are cases where jetting characteristics of the liquid is unstable.

A dispersant may be used for dispersing a pigment. Nonionic compounds, anionic compounds, cationic compounds, amphoteric compounds and the like may be used for the dispersant.

An example of the dispersant includes copolymers of monomers containing an α, β-ethylenically unsaturated group. An example of the monomer containing an α, β-ethylenically unsaturated group includes acrylic acid, methacrylic acid, crotonic acid, itaconic acid, itaconic monoester, maleic acid, maleic monoester, fumaric acid, fumaric monoester, vinylsulfonic acid, styrenesulfonic acid, sulfonated vinylnaphthalene, vinyl alcohol, acrylamide, methacryloxyethyl phosphate, bismethacyloxyethyl phosphate, methacryloxyethylphenylacido phosphate, ethylene glycol dimethacrylate, diethylene glycol dimethacrylate, styrene, styrene derivatives such as α-methylstyrene, and vinyl toluene; vinylcyclohexane, vinylnaphthalene, vinylnaphthalene derivatives; acrylic alkylesters, acrylic phenylesters, methacrylic alkylesters, methacrylic phenylesters, methacrylic cycloalkylesters, crotonic alkylesters, itaconic dialkylesters, maleic dialkylesters and the like.

Copolymers obtained by copolymerizing a single or a plurality of monomers each containing an α, β-ethylenically unsaturated group may be used as the polymer dispersant. A specific example of the copolymers includes styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, acrylic alkylester-acrylic acid copolymers, methacrylic alkylester-methacrylic acid copolymers, styrene-methacrylic alkylester-methacrylic acid copolymers, styrene-acrlic alkylester-acrylic acid copolymers, styrene-methacrylic phenylester-methacrylic acid copolymers, styrene-methacrylic cyclohexylester-methacrylic acid copolymers and the like.

It is preferred that the dispersant has 2,000 to 50,000 weight-average molecular weight.

When the molecular weight of the dispersant is less than 2,000, there are cases where the pigment is not stably dispersed in the ink, while when the molecular weight of the dispersant exceeds 50,000, there are cases where the viscosity of the ink increases, so that the ejection performance becomes worse. In this respect, more preferable weight-average molecular weight is 3,500 to 20,000.

The dispersant is used within a range of 0.01% by mass to 3% by mass. When the addition amount of the dispersant exceeds 3% by mass, there are cases where the ink viscosity increases and jetting characteristics of the ink become unstable, while when the addition amount is less than 0.01% by mass, there are cases where the dispersion stability of the pigment decreases. The addition amount of the dispersant is more preferably 0.05% by mass to 2.5% by mass, still further preferably 0.1% by mass to 2% by mass.

It is preferred that the volume-average particle diameter of the pigment is 30 nm to 250 nm. The term “volume-average particle diameter of a pigment” means either a particle diameter of a pigment itself, or a diameter of particles onto which additives adhere when an additive such as a dispersant adheres onto a colorant. In the present invention, MICROTRACK UPA GRAIN SIZE ANALYZER 9340 (trade name) manufactured by Leeds & Northrup Corporation is used as a measuring device for the volume-average particle diameter. Measurement is made by the use of 4 ml of the ink placed in a measurement cell in accordance with a predetermined measuring method. As parameters to be input in case of measurement, the ink viscosity is used as a viscosity, and the pigment density is used as a dispersion particle density.

The volume-average particle diameter is more preferably 60 nm to 250 nm, and still further preferably 150 nm to 230 nm. When the volume-average particle diameter of the particles in an ink is less than 30 nm, there are cases where the optical density decreases, while when it exceeds 250 nm, there are cases where the storage stability cannot be assured.

Next, the water-soluble solvent will be explained. Polyhydric alcohols, polyhydric alcohol derivatives, nitrogen-containing solvents, alcohols, and sulfur-containing solvents and the like are used as the water-soluble solvent.

A specific example of the polyhydric alcohols includes ethylene glycol, diethylene glycol, propylene glycol, butylene glycol, triethylene glycol, 1,5-pentanediol, 1,2,6-hexanetriol, glycerin and the like. A specific example of the polyhydric alcohol derivatives includes ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, ethylene oxide adducts of diglycerin and the like. A specific example of the nitrogen-containing solvents includes pyrrolidone, N-methyl-2-pyrrolidone, cyclohexyl pyrrolidone, triethanolamine and the like. A specific example of the alcohol solvents includes ethanol, isopropyl alcohol, butyl alcohol, benzyl alcohol and the like. A specific example of the sulfur-containing solvents includes thiodiethanol, thiodiglycerol, sulforan, dimethyl sulfoxide and the like. Propylene carbonate, ethylene carbonate and the like may be used in addition to those enumerated above. The water-soluble solvent may be used alone or in combination of two or more of them.

The addition amount of the water-soluble solvent is 1% by mass to 60% by mass, and preferably 5% by mass to 40% by mass. When the amount of the water-soluble solvent in the ink is less than 1% by mass, there are cases where sufficient optical density cannot be obtained, while when the amount of the water-soluble solvent exceeds 60% by mass, there are cases where the viscosity of the resulting ink increases, whereby jetting characteristics of the ink become unstable.

Then, the surfactant will be explained. Surfactants having required characteristics for the invention as mentioned above are suitably selected for use among those having a structure wherein hydrophilic portions exist together with hydrophobic portions in the molecule, which will be described hereafter. Specific examples of the surfactants will be explained below, but it is to be noted that the invention is not limited thereto.

For the surfactants, there are nonionic surfactants, anionic surfactants or amphoteric surfactants. The above-described dispersants may also be used. The above-described dispersants can be effectively used as the above-mentioned surfactants each having 2000 or higher weight-average molecular weight.

An example of the nonionic surfactants includes polypropylene glycol ethylene oxide adducts, polyoxyethylene nonylphenyl ether, polyoxyethylene octylphenyl ether, polyoxyethylene dodecylphenyl ether, polyoxyethylene alkyl ethers, polyoxyethylene fatty esters, sorbitan fatty esters, polyoxyethylene sorbitan fatty esters, fatty alkylolamides, acetylene glycol, oxyethylene adducts of acetylene glycol, fatty alkanolamides, glycerin esters, sorbitan esters and the like.

Examples of the anionic surfactant include alkylbenzenesulfonates, alkylphenylsulfonates, alkylnaphthalenesulfonates, higher fatty acid salts, sulfuric ester salts of a higher fatty ester, sulfonates of a higher fatty ester, sulfuric ester salts and sulfonates of a higher alcohol ether, higher alkyl sulfosuccinates, higher alkyl phosphoric ester salts, phosphoric ester salts of a higher alcohol ethylene oxide adduct and the like. For example, dialkyl sulfosuccinates, alkyl sulfates, dodecylbenzene sulfonates, allylbenzene sulfonates, isopropylnaphthalene sulfonates, monobutylphenyl phenol monosulfonates, monobutylbiphenyl sulfonates, dibutylphenyl phenol disulfonates and the like may be also effectively used.

Examples of the amphoteric surfactant include alanine type, amidopropyl betaine type, sulfobetaine type, amidoamine oxide type, imidazoline type surfactants and the like. A specific example of amphoteric surfactants includes alkyl betaine, sulfobetaine, sulfate betaine, imidazolidone betaine, amidopropyl betaine, aminodipropionates and the like.

Examples of the cationic surfactant include tetraalkylammonium salts, alkylamine salts, benzalkonium salts, alkylpyridium salts, imidazolium salts and the like. A specific example of the cationic surfactants includes dihydroxy ethylstearyl amine, 2-heptadecenyl-hydroxyethyl imidazoline, lauryl dimethylbenzyl ammonium chloride, cetylpyridinium chloride, stearamide methylpyridium chloride and the like. Biosurfactants such as spiculisporic acid, rhamnolipid, and lysolecithin may be used in addition to those enumerated above.

It is preferred that the clouding point of the nonionic surfactant in its aqueous solution is 30° C. to 90° C., more preferably 35° C. to 85° C., and still further preferably 35° C. to 80° C. When the clouding point of the nonionic surfactant in its aqueous solution is either lower than 30° C. or higher than 90° C., there are cases where either ink reliability or ink permeability, but not both, is satisfied.

The clouding point is determined as follows. An aqueous solution containing 2% of a nonionic surfactant is warmed up to a desired temperature. Then it is confirmed visually whether or not there is a white turbidity of the aqueous solution in the warmed condition. When there is the white turbidity, it is determined that the solution exceeds its clouding point.

Particularly, from a viewpoint of improving storage stability at high temperature, the anionic surfactant is preferably selected from the group consisting of dialkyl sulfosuccinic acid, alkenyl succinic acid, alkenyl sulfosuccinic acid, polyoxyalkylenealkyl ether phosphates, polyoxyalkylenealkyl ether sulfates, and derivatives thereof.

Furthermore, the amphoteric surfactant is preferably selected from the group consisting of betaine type surfactants (e.g. amidopropyl betaine type surfactants, sulfobetaine type surfactants and the like), amidoamine oxide type surfactants, imidazoline type surfactants, alanine type surfactants, and derivatives thereof.

More preferable surfactants among these anionic surfactants and amphoteric surfactants are alkenyl succinic acid, alkenyl sulfosuccinic acid, polyoxyalkylene alkyl ether phosphates, polyoxyalkylene alkyl ether sulfates, amidopropyl betaine type surfactants, and sulfobetaine type surfactants, and still further preferably alkenyl succinic acid, alkenyl sulfosuccinic acid, polyoxyalkylene alkyl ether phosphates, and polyoxyalkylene alkyl ether sulfates.

The mass ratio of the addition amount of the nonionic surfactant to that of an anionic surfactant and/or the amphoteric surfactant is within a range of from 1:0.01 to 1:0.75, more preferably from 1:0.05 to 1:0.75, and still further preferably from 1:0.1 to 1:0.5. When the mass ratio is less than 1:0.01, there are cases where a high-temperature storage stability becomes worse, while when it exceeds 1:0.75, there are cases where its pigment dispersion stability decreases.

It is preferred that the total amount of surfactants is 5% by mass or less with respect to the whole mass of the ink, more preferably 0.01 to 4% by mass, and still further preferably 0.1 to 3% by mass. When the addition amount of the surfactants is 10% by mass or more, there are cases where optical density and storage stability of the pigment ink become worse.

Next, an explanation will be made on water. Water is added such that a specific surface tension and a specific viscosity of the resulting ink, which will be mentioned hereunder, are obtained. As to the addition amount of water, there is particularly no restriction, but it is preferably 10% by mass to 99% by mass, and more preferably 30% by mass to 80% by mass with respect to the whole mass of the ink.

In the following, suitable characteristics of the inkjet ink of the invention will be explained.

First, it is preferred that the ζ potential of the ink is −60 mV to −10 mV, more preferably −60 mV to −15 mV, and still further preferably −50 mV to −20 mV. When the ζ potential is less than −60 mV, there are cases where the water resistance decreases. In the case when the treating liquid is used together, there are cases where cohesiveness of the pigment is not assured, so that the picture quality cannot be improved. On the other hand, when the ζ potential exceeds −10 mV, there are cases where storage stability of the resulting ink cannot be assured.

The ζ potential is measured by the use of a measuring device of (trade name): ESA-8000 manufactured by Matec Applied Science Corporation in accordance with the ESA (Electrokinetic Sonic Amplitude) method, and the zeta potential is calculated by using the following formula.
Formula: ζ potential=[ESA ×η×G(α)⁻¹]/[ε×c×Δρ×V]

wherein ESA represents a pressure per a unit electric field which is obtained by measurement, η is a viscosity of a solvent, G (α)⁻¹ is a compensation item due to an inertial force, ε is a dielectric constant, c is an acoustic velocity in the solvent, Δρ is a density difference between the solvent and particles, and V is a volume fraction of the particles.

In the invention, measurement is made at a temperature of 22.0° C. in accordance with a predetermined measuring method. For the parameters of ζ potential calculation, a viscosity of the ink is used as the η, the dielectric constant of water is used as the ε, the acoustic velocity in water is used as the c, the density difference between the pigment and water is used as the Δρ, and the volume fraction of the pigment is used as the V.

The zeta potential in the ink may be adjusted, for example, in accordance with the following method. Namely, the zeta potential represents the potential amount generated from the electrical charge on the surface of the pigment, and it is determined by the electric charge density on the surface of the pigment and the electric charge condition in the ink. It may be considered that the electric charge density of the pigment surface is determined by the amount of functional groups on the pigment surface and the dissociation condition of the functional groups on the pigment surface. There is such a tendency that when either the larger amount of the functional groups appear on the pigment surface, or the more dissociation of the functional groups on the pigment surface proceeds, the higher zeta potential arises. A specific method therefor differs between the case where a pigment self-dispersible in water is used and the case where a pigment is dispersed by using a dispersant.

It is preferred that the surface tension of the ink is 20 mN/m to 60 mN/m, more preferably 20 mN/m to 45 mN/m, and still further preferably 20 mN/m to 35 mN/m. When the surface tension is less than 20 mN/m, there are cases where the ink overflows on a nozzle surface, so that a normal printing cannot be made, while when the surface tension exceeds 60 mN/m, its permeability may decrease, whereby the drying time becomes prolonged.

It is preferred that the viscosity of the ink is 1.2 mPa·s to 25.0 mPa·s, more preferably 1.5 mPa·s or more but less than 10.0 mPa·s, and still further preferably 1.8 mPa·s or more but less than 5.0 mPa·s. When the viscosity of the ink is more than 25.0 mPa·s, there are cases where ejection performance decreases, while when the viscosity is less than 1.2 mPa·s, there are cases where jetting characteristics become worse.

In the following, the inkjet ink set (hereinafter, optionally referred simply to as “ink set”) according to the invention will be explained in detail. The inkjet ink set of the invention comprises the inkjet ink of the invention and a treating liquid containing at least a flocculant. It is usually preferred that the treating liquid contains a flocculant, a water-soluble solvent, and water.

First, the flocculant will be explained. The flocculant functions to flocculate or insolubilize components of the ink. An example of such flocculants includes a material having at least a function to increase a particle diameter of a colorant (pigment), and a material having a function to separate a colorant (pigment) component of an inkjet ink from its solvent, in case of admixing it with an ink. Such flocculants include inorganic electrolytes, organic acids, inorganic acids, organic amines and the like.

Examples of the inorganic electrolyte include salts of an alkaline metal ion such as lithium ion, sodium ion, and potassium ion; or a polyvalent metal ion such as aluminum ion, barium ion, calcium ion, copper ion, iron ion, magnesium ion, manganese ion, nickel ion, tin ion, titanium ion and zinc ion; and hydrochloric acid, bromic acid, hydriodic acid, sulfuric acid, nitric acid, phosphoric acid, and thiocyanic acid; or an organic carboxylic acid such as acetic acid, oxalic acid, lactic acid, fumaric acid, citric acid, salicylic acid, and benzoic acid; or organic sulfonic acids.

A specific example of such inorganic electrolytes includes salts of alkaline metals such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate; and salts of polyvalent metals such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogenphosphate, calcium thiocyanate, calcium benzoate, calcium acetate, calcium salicylate, calcium tartrate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogenphosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate.

A specific example of the organic acids includes alginic acid, citric acid, glycine, glutamic acid, succinic acid, tartaric acid, cysteine, oxalic acid, fumaric acid, phthalic acid, maleic acid, malonic acid, lycine, malic acid, and compounds represented by the following formula (1) and derivatives thereof.

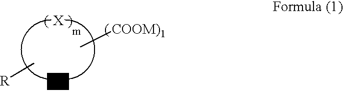

wherein X is O, CO, NH, NR₁, S or SO₂; R₁ is an alkyl group wherein the R₁ is preferably CH₃, C₂H₅, and C₂H₄OH; R is an alkyl group wherein the R is preferably CH₃, C₂H₅ and C₂H₄OH, and the R may or may not be contained in the formula; X is preferably CO, NH, NR₁ and O, and more preferably CO, NH, and O; M is a hydrogen atom, an alkaline metal or ammonium wherein the M is preferably H, Li, Na, K, monoethanolammonium, diethanolammonium, triethanolammonium and the like, more preferably H, Na, K, and still further preferably a hydrogen atom; n is an integer of 3 to 7 wherein the n is preferably such that a six-membered ring or a five-membered ring is formed in the compound, and more preferably a five-membered ring is formed; m is 1 or 2; and 1 is an integer of 1 to 5. The compounds represented by the formula (1) may be either saturated rings or unsaturated rings.

A specific example of the compounds represented by the formula (1) includes furan-, pyrrole-, pyrroline-, pyrrolidone-, pyrrone-, thiophene-, indole-, pyridine-, or quinoline-structure compounds having a carboxyl group as a functional group. A more specific example of the compounds includes 2-pyrrolidone-5-carboxylic acid, 4-methyl-4-pentanolido-3-carboxylic acid, furancarboxylic acid, 2-benzofurancarboxylic acid, 5-methyl-2-furancarboxylic acid, 2,5-dimethyl-3-furancarboxylic acid, 2,5-furandicarboxylic acid, 4-butanolido-3-carboxylic acid, 3-hydroxy-4-pyrrone-2,6-dicarboxylic acid, 2-pyrrone-6-carboxylic acid, 4-pyrrone-2-carboxylic acid, 5-hydroxy-4-pyrrone-5-carboxylic acid, 4-pyrrone-2,6-dicarboxylic acid, 3-hydroxy-4-pyrrone-2,6-dicarboxylic acid, thiophenecarboxylic acid, 2-pyrrolecarboxylic acid, 2,3-dimethylpyrrole-4-carboxylic acid, 2,4,5-trimethylpyrrole-3-propionic acid, 3-hydroxy-2-indolecarboxylic acid, 2,5-dioxo-4-methyl-3-pyrroline-3-propionic acid, 2-pyrrolidinecarboxylic acid, 4-hydroxyproline, 1-methylpyrrolidine-2-carboxylic acid, 5-carboxy-1-methylpyrrolidine-2-acetic acid, 2-pyridinecarboxylic acid, 3-pyridinecarboxylic acid, 4-pyridinecarboxylic acid, pyridinedicarboxylic acid, pyridinetricarboxylic acid, pyridinepentacarboxylic acid, 1,2,5,6-tetrahydro-1-methylnicotinic acid, 2-quinolinecarboxylic acid, 4-quinolinecarboxylic acid, 2-phenyl-4-quinolinecarboxylic acid, 4-hydroxy-2-quinolinecarboxylic acid, 6-methoxy-4-quinolinecarboxylic acid and the like.

An example of preferred organic acids includes citric acid, glycine, glutamic acid, succinic acid, tartaric acid, phthalic acid, pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, and derivatives thereof or salts thereof. An example of more preferable organic acids includes pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, and derivatives thereof or salts thereof. An example of still further preferable organic acids includes pyrrolidonecarboxylic acid, pyronecarboxylic acid, furancarboxylic acid, coumarinic acid, and derivatives thereof or salts thereof.

For the organic amine compounds, any of primary, secondary, tertiary and quaternary amines, and salts thereof may be used. A specific example of such organic amine compounds includes tetraalkylammonium, alkylamine, benzalkonium, alkylpyridium, imidazolium, polyamine, and derivatives thereof or salts thereof. A more specific example of the organic amine compounds includes amylamine, butylamine, propanolamine, propylamine, ethanolamine, ethylethanolamine, 2-ethylhexylamine, ethylmethylamine, ethylbenzylamine, ethylenediamine, octylamine, oleylamine, cyclooctylamine, cyclobutylamine, cyclopropylamine, cyclohexylamine, diisopropanolamine, diethanolamine, diethylamine, di-2-ethylhexylamine, diethylentriamine, diphenylamine, dibutylamine, dipropylamine, dihexylamine, dipentylamine, 3-(dimethylamino)propylamine, dimethylethylamine, dimethylethylenediamine, dimethyloctylamine, 1,3-dimethylbutylamine, dimethyl-1,3-propanediamine, dimethylhexylamine, amino-butanol, amino-propanol, aminopropanediol, N-acetylamino ethanol, 2-(2-aminoethylamino)-ethanol, 2-amino-2-ethyl-1,3-propanediol, 2-(2-aminoethoxy)ethanol, 2-(3,4-dimethoxyphenyl)ethylamine, cetylamine, triisopanolamine, triisopentylamine, triethanolamine, trioctylamine, tritylamine, bis(2-aminoethyl)1,3-propanediamine, bis(3-aminopropyl)ethylenediamine, bis(3-aminopropyl)1,3-propanedimaine, bis(3-aminopropyl)methylamine, bis(2-ethylhexyl)amine, bis(trimethylsilyl)amine, butylamine, butylisopropylamine, propanediamine, propydiamine, hexylamine, pentylamine, 2-methyl-cyclohexylamine, methyl-propylamine, methylbenzylamine, monoethanolamine, laurylamine, nonylamine, trimethylamine, triethylamine, dimethylpropylamine, propylenediamine, hexamethylenediamine, tetraethylenepentamine, diethylethanolamine, tetramethylammonium chloride, tetramethylammonium bromide, dihydroxyethylstearylamine, 2-heptadecenyl-hydroxyethylimidazoline, lauryldimethylbenzylammonium chloride, cetylpyridinium chloride, stearamide methylpyridinium chloride, diallyldimethylammonium chloride polymer, diallylamine polymer, monoallylamine polymer and the like.

An example of more preferable organic amine compounds includes triethanolamine, triisopropanolamine, 2-amino-2-ethyl-1,3-propanediol, ethanolamine, propanediamine, propylamine and the like.

The flocculants may be used alone or in combination of two or more of them wherein each content of them in a treating liquid is preferably 0.01 to 15% by mass, and more preferably 0.1 to 10% by mass. The total content of the flocculants in the treating liquid is preferably 0.01% by mass to 30% by mass, more preferably 0.1% by mass to 15% by mass, and still further preferably 1% by mass to 15% by mass. When the addition amount of the flocculant in the treating liquid is less than 0.01% by mass, there are cases where the flocculation of the colorant becomes insufficient in the case when the ink is in contact with the treating liquid, so that the optical density, bleeding, and intercolor bleeding become worse, while when the addition amount exceeds 30% by mass, there are cases where the jetting characteristics decrease, so that the treating liquid is not normally jetted.

In the following, the water-soluble solvent will be explained. The same water-soluble solvent as that in case of an inkjet ink may be used for the treating liquid. The content of the water-soluble solvent is 1% by mass to 60% by mass, and preferably 5% by mass to 40% by mass. When the amount of the water-soluble solvent in the liquid is less than 1% by mass, there are cases where sufficient optical density is not obtained, while when the amount of the organic solvent is more than 60% by mass, there are cases where the viscosity of the liquid is increased, so that jetting characteristics of the treating liquid become unstable.

Next, water will be explained. Water may be added such that the after-mentioned surface tension and viscosity are obtained. Although the addition amount of water is not particularly restricted, it is preferably 10% by mass to 99% by mass with respect to the whole treating liquid, and more preferably 30% by mass to 80% by mass.

In the following, the other additives for the treating liquid will be explained.

A colorant may be allowed to be contained in the treating liquid wherein those to be contained in the treating liquid are preferably dyes, pigments on the surface of which sulfonic acids or sulfonic salts are contained, and self-dispersible pigments. It is considered that these colorants are hardly flocculated even in coexistence with a flocculant. When such colorants as mentioned above are used, the storage stability of the treating liquid does not become worse. Pigments as those explained for the inkjet ink or the same dyes as those well-known may be used for the above-mentioned dyes, pigments on the surface of which sulfonic acids or sulfonic salts are contained, and self-dispersible pigments.

In the case where a pigment is used in a treating liquid, it is preferred that the volume-average particle diameter of the pigment particles is 30 nm to 250 nm, more preferably 50 nm to 200 nm, and still further preferably 75 nm to 175 nm. When the volume-average particle diameter of the particles in a liquid is less than 30 nm, there are cases where the optical density decreases, while when it exceeds 250 nm, there are cases where the storage stability cannot be assured.

In the treating liquid, the same surfactants as those of the inkjet ink may be used. It is preferred that the amount of the surfactant is less than 10% by mass with respect to the whole mass of the treating liquid, more preferably 0.01 to 5% by mass, and still further preferably 0.01 to 3% by mass. When the addition amount of the surfactant is 10% by mass or more, there are cases where the optical density and storage stability of the ink become worse.

Next, preferable physical properties of the treating liquid will be explained. It is preferred that the surface tension of the treating liquid is 20 mN/m to 45 mN/m, more preferably 20 mN/m to 39 mN/m, and still further preferably 20 mN/m to 35 mN/m. When the surface tension is less than 20 mN/m, there are cases where the liquid overflows on a nozzle surface, whereby a normal printing cannot be made, while when it exceeds 45 mN/m, there are cases where its permeability decreases, so that the drying time becomes longer.

It is preferred that the viscosity of the treating liquid is 1.2 mPa·s to 25.0 mPa·s, more preferably 1.5 mPa·s or more but less than 10.0 mPa·s, and still further preferably 1.8 mPa·s or more but less than 5.0 mPa·s. When the viscosity is more than 25.0 mPa·s, there are cases where ejection performance decreases, while when it is less than 1.2 mPa·s, there are cases where the long term storage stability becomes worse.

It is preferred that the number of coarse particles each having 5 μm or more size in a mixed liquid of the ink and the treating liquid is 1,000/μL or more, more preferably 2,500/μL or more, and still further preferably 5,000/μL or more. When the number of coarse particles each having 5 μm or more size in the mixed liquid of the ink and the treating liquid is less than 1,000/μL, there are cases where the optical density decreases.

The number of coarse particles each having 5 μm or more size in the mixed liquid of the ink and the treating liquid is measured in such a manner that these two liquids are admixed in 1:1 mass ratio with each other, 2 μL are taken out while stirring them, and measured by using a (trade name): ACCUSIZER ™770 OPTICAL PARTICLE SIZER made by Particle Sizing Systems Corporation wherein the density of the pigment is input for a density of dispersed particles as a parameter at the time of measurement. Such density of the pigment may be determined by measuring a powder obtained by heating and drying a colored fine particle dispersion with the use of a hydrometer, pycnometer and the like.

For the purpose of controlling characteristics such as an improvement in an ejection performance, materials other than those mentioned above such as polyethyleneimine; polyamines; polyvinylpyrrolidone; polyethyleneglycol; cellulose derivatives such as ethylcellulose, and carboxymethylcellulose; polysaccarides and derivatives thereof; other water-soluble polymers; polymer emulsions such as acryl-base polymer emulsions, polyurethane-base emulsions, and hydrophilic latexes; hydrophilic polymer gels; cyclodextrins; macrocyclic amines; dendrimers; crownethers; urea and derivatives thereof; acetamide; silicone type surfactants; and fluorine type surfactants may be used.

In order to adjust the electric conductivity and pH, compounds of alkaline metals such as potassium hydroxide, sodium hydroxide, and lithium hydroxide; nitrogen-containing compounds such as ammonium hydroxide, triethanolamine, diethanolamine, ethanolamine, and 2-amino-2-methyl-1-propanol; compounds of alkaline earth metals such as calcium hydroxide; acids such as sulfuric acid, hydrochloric acid, and nitric acid; and salts of strong acids and weak alkalis such as ammonium sulfate may be used.

In addition to the above, pH buffers, antioxidants, fungicides, viscosity modifiers, conductant agents, and ultraviolet absorbers may also be added, if required.

(Inkjet Ink Tank)

The inkjet ink tank is a container for storing the above-described inkjet ink of the invention, or the above-described respective liquids in an inkjet ink set of the invention, for example, an ink tank described in Japanese Patent Application Laid-Open No. 2001-138541 and the like is applicable. In this case, when the ink tank is filled with the ink and the ink is ejected from a recording head, changes in ink characteristics in case of long term storage in the ink tank can be suppressed, and particularly jetting performance after long term storage is sufficiently satisfied.

(Inkjet Recording Method, Inkjet Recording Apparatus)

The inkjet recording method of the invention is a method for ejecting the above-described inkjet ink of the invention or the respective liquids in the inkjet ink set of the invention onto a recording medium to form a picture image. In case of using the above-described inkjet ink set of the invention, its inks may be ejected onto the recording medium so as to be in contact with the treating liquids to form a picture image.

The inkjet recording apparatus of the invention is provided with a recording head for ejecting the inkjet ink of the invention or the respective liquids in the inkjet ink set of the invention onto a recording medium.

In the present invention, a recording apparatus provided with a heater for controlling a drying of inks, and a recording apparatus provided with an intermediate transfer mechanism wherein inks and treating liquids are ejected (printed) on the intermediate and then the printed image is transferred on a recording medium such as papers and the like can be used in addition to an ordinary inkjet recording apparatus.

In the inkjet recording method (apparatus) of the invention, it is preferred that the liquid mass per a drop of each of the inks and the treating liquid is 25 ng or less, more preferably 0.5 ng to 20 ng, and still further preferably 1 ng to 8 ng. When the liquid mass per a drop exceeds 25 ng, there are cases where bleeding becomes worse. This may be because the contact angle of each of the inks and the treating liquid with respect to the recording medium changes dependent upon the amount of drops, and because there is such a tendency that the drops easily expand in surface directions of the paper with the increase of the amount of drops. In this case, however, it is to be noted that the above-described amount of drop means an amount of the minimum drop being printable in an inkjet device by which variable amount of drop can be jetted from one nozzle.

In case of using the inkjet ink set, the inks may be ejected onto a recording medium so as to be in contact with the treating liquid. When the inkjet inks are contacted with the treating liquid, inks are flocculated by the effect of a flocculant, so that the recording method excellent in color developing properties, surface irregularity in a solid image area, optical density, bleeding, intercolor bleeding, and drying time is achieved. In this case, either a contact condition wherein both the components are adjacent to each other, or a contact condition wherein both the components overlap one another is applicable so far as the both components are in contact with each other.

The application order of the both components on a recording medium is such that a treating liquid is applied, and then an inkjet ink is applied. This is because when the treating liquid is first applied, it becomes possible to effectively flocculate constitutional components of the inkjet ink. After completing the application of the treating liquid, the inkjet ink may be applied at any time. It is preferred to apply the inkjet ink at 0.1 second or less after applying the treating liquid.

Furthermore, it is preferred that the mass ratio of the ink ejection amount to the treating liquid ejection amount for forming one picture element is from 1:20 to 20:1, more preferably from 1:10 to 10:1, and still further preferably from 1:5 to 5:1. When too large or too small amount of the inkjet ink is applied with respect to the amount of the treating liquid, there are cases where flocculation becomes insufficient, so that decrease in optical density, bad bleeding, and bad intercolor bleeding arise. In this case, the picture element means a lattice point formed such that a picture image is divided in horizontal scanning and vertical scanning directions into minimum areas on which an ink can be applied. When suitable ink sets are applied to respective picture elements, color and density are adjusted to form a picture image.

From viewpoints of effects for improving bleeding and intercolor bleeding, the inkjet recording method (apparatus) of the invention preferably adopts a thermal inkjet recording method, or piezo inkjet recording method. The reason of which is not clear. In case of the thermal inkjet recording method, however, inks are heated at the time of ejection, resulting in low viscosity of them, but the temperature of the inks decreases on the recording medium, whereby the viscosity increases rapidly. For this phenomenon, it may be considered that effects for improving bleeding and intercolor bleeding are attained.

On one hand, in case of a piezo inkjet method, it is estimated that a liquid having a high viscosity can be ejected, whereby the liquid of a high viscosity can control its expansion in the surface directions on a recording medium, so that there are effects for improving bleeding and intercolor bleeding.

In the inkjet recording method (apparatus) of the invention, replenishment (supply) of inks and a treating liquid to the recording head is desirably made from ink tanks (including a treating liquid tank) filled with the inks or respective liquids of the treating liquid. The ink tank may be a cartridge type detachable to the apparatus. When the cartridge type ink tank is exchanged, replenishment of the inks and the treating liquid can be easily performed.

In the following preferred embodiments of the inkjet recording apparatus of the invention will be explained by referring to the accompanying drawings wherein components having substantially the same functions as those of the others are designated by the same reference characters, and overlapped explanations therefor are omitted.

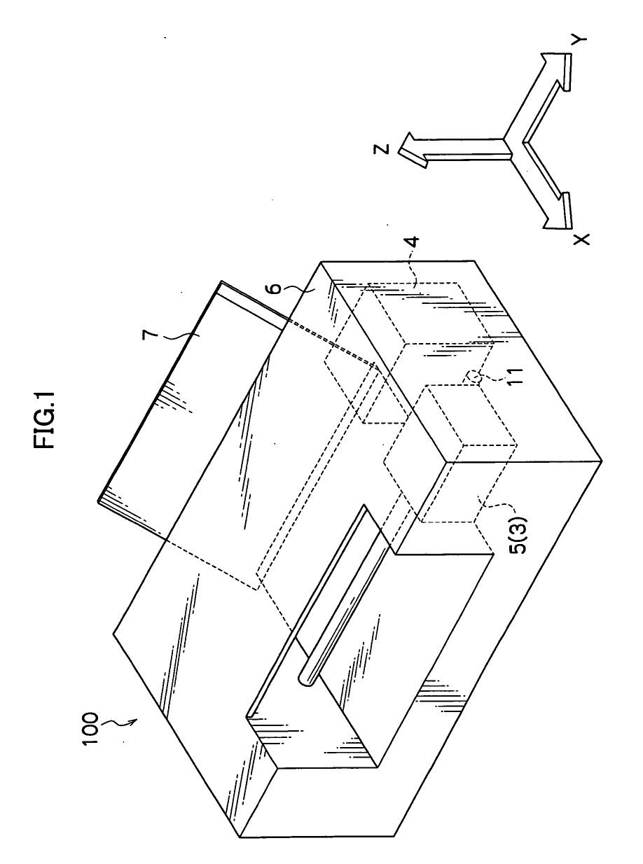

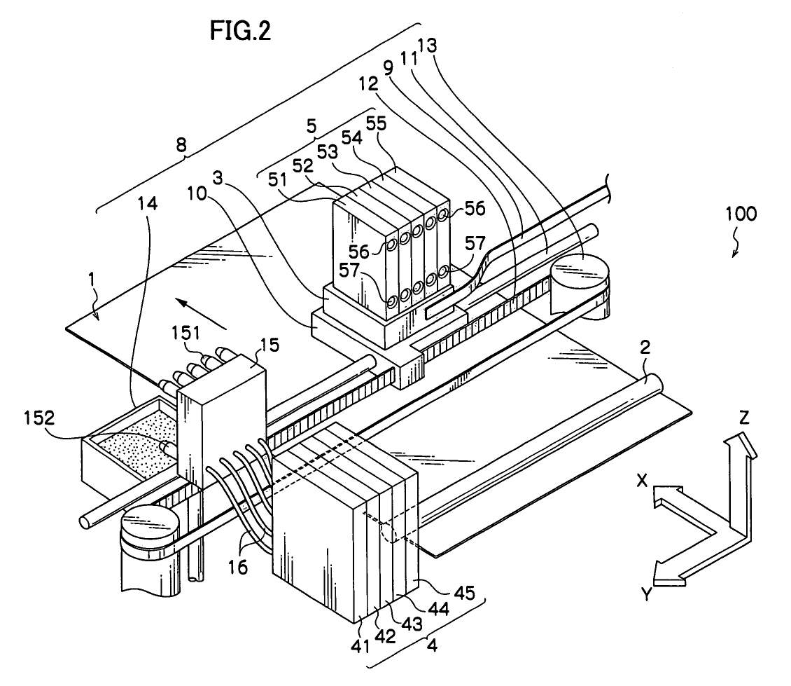

FIG. 1 is a perspective view showing a configuration of an external appearance of a preferred embodiment of the inkjet recording apparatus of the invention, and FIG. 2 is a perspective view showing a key structure of the interior of the inkjet recording apparatus (hereinafter referred to as “picture image forming apparatus”) of FIG. 1.

The picture image forming apparatus 100 of the present embodiment has a configuration functioning to form picture images in accordance with the above-mentioned inkjet recording method of the invention. Namely, as shown in FIGS. 1 and 2, the picture image forming apparatus 100 is essentially composed of an outer cover 6, a tray 7 on which a predetermined amount of a recording medium 1 such as plain papers can be placed, feed rollers (conveying means) 2 for feeding each one of the recording media 1 to the interior of the image forming apparatus 100, a picture image forming section 8 (image forming means) for ejecting inks and a treating liquid on the surface of the recording medium 1 to form a picture image, and a main ink tank 4 for replenishing inks and a treating liquid to respective sub ink tanks 5 in the image forming section 8.

The feed rollers 2 are a paper handling mechanism composed of a pair of rollers provided rotatably in the picture image forming apparatus 100, and which holds the recording media 1 set in the tray 7 and feeds each one of the recording media 1 to the interior of the apparatus 100 at a predetermined timing and extent.

In the image forming section 8, a picture image is formed with inks on a surface of the recording medium 1. The picture image forming section 8 is principally composed of a recording head 3, a sub ink tank 5, a feeding signal cable 9, a carriage 10, a guide rod 11, a timing belt 12, driving pulleys 13, and a maintenance unit 14.

The sub ink tank 5 includes respective sub ink tanks 51, 52, 53, 54, and 55, which store inks having different colors, respectively, and a treating liquid in a condition where they can be ejected from the recording head. In these sub ink tanks, for example, a black ink (K), an yellow ink (Y), a magenta ink (M), and a cyan ink (C) as first liquids, and a treating liquid as a second liquid are replenished from the main ink tank 4 and stored in them, respectively.

In the ink tank 5, exhaust ports 56 and replenishment ports 57 are each provided. When the recording head 3 is moved to a standby position (or a replenishment position), exhaust pins 151 and replenishment pins 152 of a replenishment device 15 are inserted into the exhaust ports 56 and the replenishment ports 57, respectively, the sub ink tank 5 can be connected to the replenishment device 15. The replenishment device 15 is connected to the main ink tank 4 through replenishment tubes 16. By means of the replenishment device 15, the inks or the treating liquid is replenished from the main ink tank 4 to the sub ink tank 5 through the replenishment ports 57.

The main ink tank 4 also includes each of main ink tanks 41, 42, 43, 44, and 45, which store inks of different colors and a treating liquid, respectively. In these main ink tanks, for example, a black ink (K), an yellow ink (Y), a magenta ink (M), and a cyan ink (C) as first liquids, and a treating liquid as a second liquid are replenished, and these main ink tanks are stored detachably in the image forming apparatus 100, respectively.

To the recording head 3, the feeding signal cable 9 and the sub ink tank 5 are connected. When external picture image recording information is input to the recording head 3 through the feeding signal cable 9, the recording head 3 sucks a predetermined amount of each ink from the respective ink tanks based on the picture image recording information to eject the inks on the surface of a recording medium. The feeding signal cable 9 functions also to supply an electric power required for driving the recording head 3 thereto in addition to function as a path for the picture image recording information.

The recording head 3 is placed on the carriage 10 and held thereon wherein the carriage 10 is connected to the guide rod 11, and the timing belt 12 which is engaged with the driving pulleys 13. Due to such configuration, the recording head 3 becomes also movable in a direction Y (horizontal scanning direction) parallel to a plane of the recording medium 1 and perpendicular to a feeding direction X (vertical scanning direction) of the recording medium 1 so as to be along with the guide rod 11.

The picture image forming apparatus 100 is provided with a control means (not shown) for adjusting a driving timing of the recording head 3 and a driving timing of the carriage 10 based on picture image recording information. In this manner, a picture image based on the picture image recording information can be continuously formed on a predetermined area on a surface of the recording medium 1 fed along the feeding direction X at a predetermined rate.

The maintenance unit 14 is connected to a pressure reducing device (not shown) through a tube. The maintenance unit 14 sucks inks through the nozzles in the recording head 3 by connecting to a nozzle portion of the recording head 3 and making the inside pressure of nozzles of the recording head 3 lowered. As a result of providing the maintenance unit 14, it is possible to remove extra inks remained on nozzles during an operation of the picture image forming apparatus 100, as occasion demands, or to suppress evaporation of inks from the nozzles in the case where operations of the picture image forming apparatus are stopped.

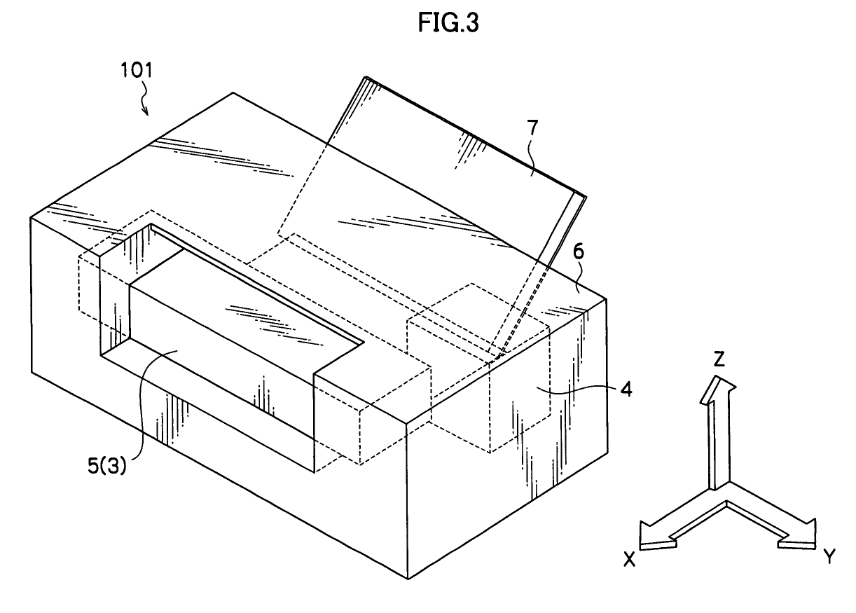

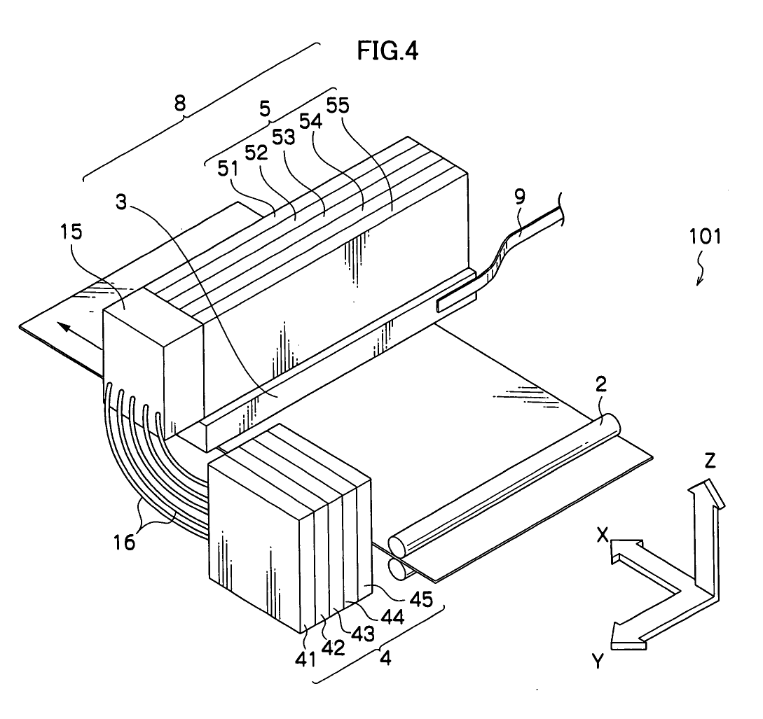

FIG. 3 is a perspective view showing a configuration of an external appearance of another preferred embodiment of the inkjet recording apparatus of the invention, and FIG. 4 is a perspective view showing a key structure of the interior of the inkjet recording apparatus (hereinafter, referred to as “picture image forming apparatus”) of FIG. 3.

A picture image forming apparatus 101 has such a configuration that it is operated based on the above-mentioned inkjet recording method of the invention to form picture images.

The picture image forming apparatus shown in FIGS. 3 and 4 involves a recording head 3 having a width equal to or longer than that of a recording medium 1, does not involve a carriage mechanism, and is provided with a paper feeding mechanism in a vertical scanning direction (a feeding direction of the recording medium 1: the arrow of X direction) (although feeding rollers 2 are shown in the present embodiment, they may be, for example, a paper handling mechanism of a belt type).

Although they are not shown in the figures, sub ink tanks 51 to 55 are sequentially disposed in the vertical scanning direction (the feeding direction of the recording medium 1: the arrow of X direction), and a group of nozzles for ejecting respective color inks (including a treating liquid) are also disposed in the vertical scanning direction. The configuration other than those described above are the same as that of the picture image forming apparatus 100 shown in FIGS. 1 and 2, so that the explanation thereof is omitted.

In FIGS. 3 and 4, since the recording head 3 is not moved, such a configuration where the sub ink tanks 5 are always linked to a replenishment device 15 is shown. However, the sub ink tanks 5 may be linked to the replenishment device 15 at the time of replenishing inks.

In the picture image forming apparatus 101 shown in FIGS. 3 and 4, since a printing in a width direction (the horizontal scanning direction) of the recording medium 1 is implemented with the recording head 3 in one lump, a configuration of the apparatus is simpler than that of an apparatus having a carriage mechanism, and also a printing speed is faster.

### EXAMPLES

In the following, the present invention will be explained in more specifically by referring to examples, but it is to be noted that the invention is not limited by these examples.

<Treating Method 1 for Pigment>

An ultrasonic homgenizer is applied to commercially available pigment dispersion liquid. Then, the resulting dispersion liquid is subjected to a centrifugation treatment (8000 rpm×30 minutes) to remove the residual part (20% of an initial charge), whereby a pigment dispersion liquid is obtained.

<Treating Method 2 for Pigment>

Ten % by mass of a pigment and 1.5% by mass of a dispersant are added into a predetermined amount of an ion-exchange water, and the mixture is stirred. An ultrasonic homgenizer is applied to the resulting mixed liquid to disperse a pigment. Then, the dispersion liquid is subjected to a centrifugation treatment (8000 rpm×30 minutes) to remove the residual part (20% of an initial charge), whereby a pigment dispersion liquid is obtained.

<Treating Method 3 for Pigment>

An aqueous sulfanilic acid solution is warmed up, and 100 g of a pigment is added thereto while stirring. The mixture is cooled to a room temperature while stirring, and 14 g of concentrated nitric acid are dropped thereto. To the resulting solution, 10 g of NaNO₂ aqueous solution are added, and the mixture is stirred until the reaction is completed. The pigment is desalted. To the resulting surface-treated pigment, an ion-exchange water is added so as to obtain 12 wt % pigment concentration, a pH thereof is adjusted to be 7.5, and then, an ultrasonic homogenizer is applied thereto to disperse the solution. The resulting dispersion liquid is centrifuged (8000 rpm×30 minutes) by using a centrifugal separator to remove the residual part (20% of a total amount), whereby a pigment dispersion liquid is obtained.

<Preparing Method of Ink>

To obtain a predetermined composition, a colorant solution, a water-soluble organic solvent, a surfactant, an ion-exchange water and the like are added in each proper amount, the mixed liquid is admixed and stirred. The resulting liquid is allowed to pass through 5 μm filter to obtain a desired liquid.

(Ink A)

The pigment treated in accordance with the treating method 1 for pigment is used, and an ink is prepared according to a predetermined method.

-Composition-

(Trade name): CABOJET-300 (manufactured by Cabs Corporation): 4% by mass
Styrene-acrylic acid-sodium acrylate copolymer: 1% by mass (weight-average molecular weight 5500)
Diethylene glycol: 20% by mass
Propylene glycol: 5% by mass
Acetylene glycol ethylene oxide adduct: 1% by mass (weight-average molecular weight 667, SP value 10.3, the number of carbon and oxygen atoms in a hydrophilic group unit 32)
Sodium polyoxyethylene lauryl ether sulfate: 0.15% by mass (weight-average molecular weight 394)
Ion-exchange water: the balance

The ink has −22 mV ζ potential, 3.3 mPa·s viscosity, 85 nm volume-average particle diameter, and 30 mN/m surface tension.

(Ink B)

The pigment treated in accordance with the treating method 2 for pigment is used, and an ink is prepared according to a predetermined method.

-Composition-

(Trade name): BLACK PERLS L (manufactured by Cabs Corporation): 4% by mass
Styrene-acrylic acid-sodium acrylate copolymer: 0.6% by mass (weight-average molecular weight 4500)
Diethylene glycol: 20% by mass
Ethylene glycol: 5% by mass
Polyoxyethylene isostearyl ether: 0.75% by mass (weight-average molecular weight 622, SP value 9.4, the number of carbon and oxygen atom in a hydrophilic group unit 25)
Sodium dioctyl sulfosuccinate: 0.2% by mass (weight-average molecular weight 445)
Ion-exchange water: the balance

The ink has −31 mV ζ potential, 3.1 mPa·s viscosity, 110 nm volume-average particle diameter, and 33 mN/m surface tension.

(Ink C)

The pigment treated in accordance with the treating method 3 for pigment is used, and an ink is prepared according to a predetermined method.

-Composition-

C.I. Pigment Blue-15:3: 5% by mass
Styrene-acrylic acid-sodium acrylate copolymer: 1% by mass (weight-average molecular weight 4000)
Diethylene glycol: 20% by mass
Glycerin: 5% by mass
Polyoxyethylene 2-ethylhexyl ether: 0.75% by mass (weight-average molecular weight 306, SP value 10.0, the number of carbon and oxygen atoms in a hydrophilic group unit 13)
Dimethyl lauryl betaine: 0.2% by mass (weight-average molecular weight 294)
Ion-exchange water: the balance

The ink has −55 mV ζ potential, 3.5 mPa·s viscosity, 75 nm volume-average particle diameter, and 30 mN/m surface tension.

(Ink D)

The pigment treated in accordance with the treating method 3 for pigment is used, and an ink is prepared according to a predetermined method.

-Composition-

C.I. Pigment Red-122: 4% by mass
Styrene-acrylic acid-sodium acrylate copolymer: 1% by mass (weight-average molecular weight 6000)
Diethylene glycol: 15% by mass
Propylene glycol: 5% by mass
Butyl carbitol: 3% by mass
Acetylene glycol ethylene oxide adduct: 0.75% by mass (weight-average molecular weight 667, SP value 10.3, the number of carbon and oxygen atoms in a hydrophilic group unit 32)
Sodium dioctyl sulfosuccinate: 0.15% by mass (molecular weight 445)
Ion-exchange water: the balance

The ink has −38 mV ζ potential, 2.9 mPa·s viscosity, 96 nm volume-average particle diameter, and 31 mN/m surface tension.

(Ink E)

The pigment treated in accordance with the treating method 3 for pigment is used, and an ink is prepared according to a predetermined method.

-Composition-

C.I. Pigment Yellow-128: 4% by mass
Styrene-acrylic acid-sodium acrylate copolymer: 1% by mass (weight-average molecular weight 6000)
Diethylene glycol: 20% by mass
Sulforan: 5% by mass
Acetylene glycol ethylene oxide adduct: 0.75% by mass (weight-average molecular weight 667, SP value 10.3, the number of carbon and oxygen atoms in a hydrophilic group unit 32)
Di-2-ethylhexyl sulfosuccinic acid: 0.15% by mass (molecular weight 445)
Ion-exchange water: the balance

The ink has −18 mV ζ potential, 3.3 mPa·s viscosity, 112 nm volume-average particle diameter, and 31 mN/m surface tension.

(Ink F)

The pigment treated in accordance with the treating method 3 for pigment is used, and an ink is prepared according to a predetermined method.

-Composition-

C.I. Pigment Red-122: 4% by mass
Styrene-acrylic acid-sodium acrylate copolymer: 0.75% by mass (weight-average molecular weight 6000)
Diethylene glycol: 20% by mass
2-Pyrrolidone: 5% by mass
Acetylene glycol ethylene oxide adduct: 0.75% by mass (weight-average molecular weight 667, SP value 10.3, the number of carbon and oxygen atoms in a hydrophilic group unit 32)
Sodium succinate: 0.2% by mass (molecular weight 164)
Ion-exchange water: the balance

The ink has −35 mV ζ potential, 3.0 mPa·s viscosity, 88 nm volume-average particle diameter, and 31 mN/m surface tension.

(Ink G)

The pigment treated in accordance with the treating method 3 for pigment is used, and an ink is prepared according to a predetermined method.

-Composition-

C.I. Pigment Red-122: 5% by mass
Styrene-acrylic acid-sodium acrylate copolymer: 0.6% by mass (weight-average molecular weight 6000)
Diethylene glycol: 20% by mass
Propylene glycol: 5% by mass
Acetylene glycol ethylene oxide adduct: 0.75% by mass (weight-average molecular weight 1550, SP value 9.8, the number of carbon and oxygen atoms in a hydrophilic group unit 92)
Di-2-ethylhexyl sulfosuccinic acid: 0.2% by mass (molecular weight 445)
Ion-exchange water: the balance

The ink has −28 mV ζ potential, 3.8 mPa·s viscosity, 104 nm volume-average particle diameter, and 36 mN/m surface tension.

(Ink H)

The pigment treated in accordance with the treating method 3 for pigment is used, and an ink is prepared according to a predetermined method.

-Composition-

C.I. Pigment Red-122: 3.5% by mass
Styrene-acrylic acid-sodium acrylate copolymer: 0.8% by mass (weight-average molecular weight 6000)
Diethylene glycol: 20% by mass
Glycerin: 5% by mass
1,2-Hexanediol: 0.75% by mass (weight-average molecular weight 119, SP value 13.4, the number of carbon and oxygen atoms in a hydrophilic group unit 4)
Di-2-ethylhexyl sulfosuccinic acid: 0.15% by mass (molecular weight 445)
Ion-exchange water: the balance

The ink has −36 mV ζ potential, 3.2 mPa·s viscosity, 91 nm volume particle diameter, and 38 mN/m surface tension.

(Ink I)

The pigment treated in accordance with the treating method 3 for pigment is used, and an ink is prepared according to a predetermined method.

-Composition-

C.I. Pigment Red-122: 4% by mass
Diethylene glycol: 22% by mass
Propylene glycol: 5% by mass
Diethylene glycol monobutyl ether: 0.75% by mass (weight-average molecular weight 162, SP value 10.5, the number of carbon and oxygen atoms in a hydrophilic group unit 6)
Di-2-ethylhexyl sulfosuccinic acid: 0.15% by mass (molecular weight 444.6)
Ion-exchange water: the balance

The ink has −34 mV ζ potential, 3.0 mPa·s viscosity, 78 nm volume-average particle diameter, and 37 mN/m surface tension.

(Ink J)

The pigment treated in accordance with the treating method 3 for pigment is used, and an ink is prepared according to a predetermined method.

-Composition-

C.I. Pigment Red-122: 4% by mass
Diethylene glycol: 22% by mass
Propylene glycol: 5% by mass
Polyoxyethylene unirine ether: 0.75% by mass (weight-average molecular weight 530, SP value 9.15, the number of carbon and oxygen atoms in a hydrophilic group unit 10)
Di-2-ethylhexyl sulfosuccinic acid: 0.15% by mass (molecular weight 444.6)
Ion-exchange water: the balance

The ink has −38 mV ζ potential, 3.3 mPa·s viscosity, 91 nm volume-average particle diameter, and 36 mN/m surface tension.

(Ink K)

The pigment treated in accordance with the treating method 3 for pigment is used, and an ink is prepared according to a predetermined method.

-Composition-

C.I. Pigment Red-122: 4% by mass
Diethylene glycol: 22% by mass
Propylene glycol: 5% by mass
Acetylene glycol ethylene oxide adduct: 0.75% by mass (weight-average molecular weight 667, SP value 10.3, the number of carbon and oxygen atoms in a hydrophilic group unit 32)
n-Butyl acrylate-acrylic acid copolymer: 0.2% by mass (molecular weight 1700)
Ion-exchange water: the balance

The ink has −30 mV ζ potential, 3.5 mPa·s viscosity, 83 nm volume-average particle diameter, and 32 mN/m surface tension.

Characteristics of the inks as enumerated above are collectively shown in Table 1.

(Treating Liquid A)

-Composition-

Diethylene glycol: 30% by mass
2-Francarboxylic acid (pKa=2.4): 8% by mass
Sodium hydroxide: 0.8% by mass
Acetylene glycol ethylene oxide adduct: 1% by mass
Ion-exchange water: the balance

The liquid has 3.8 pH, 31 mN/m surface tension, and 2.7 mPa·s viscosity.

(Treating Liquid B)

-Composition-

Diethylene glycol: 30% by mass
Succinic acid (pKa=4.0): 2% by mass
Magnesium nitrate•hexahydrate: 4% by mass
Sodium hydroxide: 0.9% by mass
Acetylene glycol ethylene oxide adduct: 1% by mass
Ion-exchange water: the balance

The liquid has 3.6 pH, 32 mN/m surface tension, and 2.8 mPa·s viscosity. (Examples 1 to 9, Comparative examples 1 to 9)

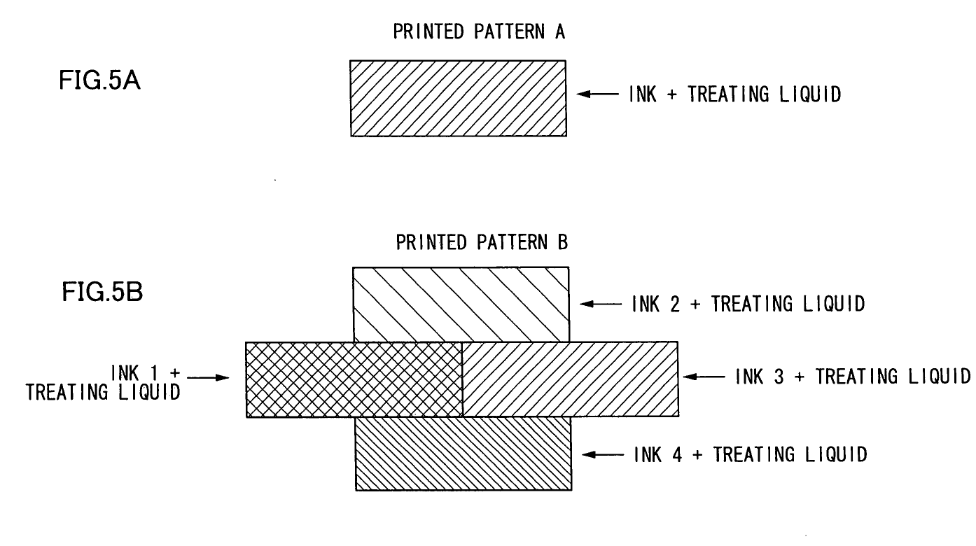

Printing is made by using inks or ink sets prepared in accordance with Table 2 to Table 4 wherein the printing is implemented in such a method that a prototype print head of 800 dpi and 256 nozzles (14 ng drop amount) is used, and inks and/or a treating liquid are ejected with respect to (trade name): FX-C² PAPER (manufactured by Fuji Xerox Corporation) in accordance with a printing pattern. The printing is made under an ordinary environment (23±0.5° C. temperature, 55±5% relative humidity). In case of ejecting an ink and a treating liquid, a mass ratio of an applied amount of an ink and a treating liquid for forming one picture element is 1:0.2. Evaluations are made upon each of printing samples having been allowed to stand for 24 hours under the ordinary environment after printing (excluding a drying time and a high-temperature storage stability). A printing pattern A shown in FIG. 5A is used in case of evaluating a single color ink, while a printing pattern B shown in FIG. 5B is used in case of evaluating plural color inks.

The results thereof are shown in Table 2 to Table 4.

(Evaluation)

<<Intercolor Bleeding>>

Concerning an evaluation of intercolor bleeding, a pattern wherein different colors are adjacent to each other is printed, a degree of bleeding in a boundary area is collated with boundary samples which have been previously prepared, and sensory evaluation is performed.

-Evaluation Standard-

◯ . . . Slight bleeding

Δ . . . Bleeding appears, but in an allowable level

× . . . Remarkable bleeding, and out of the allowable level

<<Bleeding>>

A thin line pattern is printed, a degree of bleeding in a printed area is collated with boundary samples, and sensory evaluation is performed.

-Evaluation Standard-

◯ . . . Slight bleeding

Δ . . . Bleeding appears, but in an allowable level

× . . . Remarkable bleeding, and out of the allowable level

<<Drying Time>>

A 100% coverage pattern is printed, and after a predetermined period of time laspes, a separate FX-C² paper is pushed to the printed pattern under 1.9×10⁴ N/m² load. In this case, a drying time is a period of time until a liquid is not transferred to the FX-C² paper which has been pushed to the printed pattern.

-Evaluation Standard-

◯ . . . Drying time is less than one second

Δ . . . Drying time is one second or more but less than five seconds

× . . . Drying time is five seconds or more

<<High-Temperature Storage Stability>>

Concerning a high-temperature storage stability, each ink is stored at a temperature of 75° C. for one month, and an ink viscosity and an ink dispersion particle diameter at a starting time are compared with those after lapse of one month.

-Evaluation Standard-

◯ . . . Percent change of a value after the lapse of one month to that of the starting time is less than 10%

Δ . . . Percent change of a value after the lapse of one month to that of the starting time is 10% or more but less than 20%

× . . . Percent change of a value after the lapse of one month to that of the starting time is 20% or more

TABLE 1

| | Nonionic Surfactant | | | | | | | | | |
|---|---|---|---|---|---|---|---|---|---|---|
| | | | Sum of | | | | | | | |
| | | | Number | | Anionic | Ratio of | | | | |
| | | | of | | (Amphoteric) | Nonionic | Ink Characterisitics | | | |
| | | | Carbon. | Clouding | Surfactant | Surfactant:Anionic | | | Volume-average | Surface |
| | Molecular | | Oxygen | Point | Molecular | (Amphoteric) | ζ Potential | Viscosity | Particle | Tension |
| | Weight | SP Value | Atoms | 30° C. to 90° C. | Weight | Surfactant | mV | mPa · s | Diameter nm | mN/m |
| Ink A | 667 | 10.3 | 32 | ◯ | 394/5500* | 1:0.15 | −22 | 3.3 | 85 | 30 |
| Ink B | 622 | 9.4 | 25 | ◯ | 445/4500* | 1:0.27 | −31 | 3.1 | 110 | 33 |
| Ink C | 306 | 10.0 | 13 | ◯ | 294/4000* | 1:0.27 | −55 | 3.5 | 75 | 30 |
| Ink D | 667 | 10.3 | 32 | ◯ | 445/6000* | 1:0.20 | −38 | 2.9 | 96 | 31 |
| Ink E | 667 | 10.3 | 32 | ◯ | 445/6000* | 1:0.20 | −18 | 3.3 | 112 | 31 |
| Ink F | 667 | 10.3 | 32 | ◯ | 164/6000* | 1:0.27 | −35 | 3.0 | 88 | 31 |
| Ink G | 1550 | 9.8 | 92 | ◯ | 445/6000* | 1:0.27 | −28 | 3.8 | 104 | 36 |
| Ink H | 119 | 13.4 | 4 | X | 445/6000* | 1:0.20 | −36 | 3.2 | 91 | 38 |
| Ink I | 162 | 10.5 | 6 | X | 444.6 | 1:0.20 | −34 | 3.0 | 78 | 37 |
| Ink J | 530 | 9.15 | 10 | X | 444.6 | 1:0.20 | −38 | 3.3 | 91 | 36 |
| Ink K | 667 | 10.3 | 32 | ◯ | 1700 | 1:0.27 | −30 | 3.5 | 83 | 32 |

*A right side numerical value in a column of the Anionic (Amphoteric) Surfactant means a molecular weight of a surfactant having a weight-average molecular weight of 2000 or more.

TABLE 2

| | | | | High-temperature |
|---|---|---|---|---|
| | | | Drying | Storage |
| | Ink | Bleeding | Time | stability |
| Example 1 | A | ◯ | ◯ | ◯ |
| Example 2 | B | ◯ | ◯ | ◯ |
| Example 3 | C | ◯ | ◯ | ◯ |
| Example 4 | D | ◯ | ◯ | ◯ |
| Example 5 | E | ◯ | ◯ | ◯ |
| Comparative Example 1 | F | ◯ | ◯ | X |
| Comparative Example 2 | G | ◯ | X | X |
| Comparative Example 3 | H | ◯ | X | ◯ |
| Comparative Example 4 | I | ◯ | X | ◯ |
| Comparative Example 5 | J | X | ◯ | ◯ |
| Comparative Example 6 | K | X | ◯ | X |

TABLE 3

| | Ink Set | | | | High-temperature |
|---|---|---|---|---|---|
| | | Treating | | Drying | Storage |
| | Ink | Liquid | Bleeding | Time | stability |
| Example 6 | A | A | ◯ | ◯ | ◯ |
| Example 7 | B | B | ◯ | ◯ | ◯ |
| Example 8 | C | A | ◯ | ◯ | ◯ |
| Comparative | F | A | ◯ | ◯ | X |
| Example 7 | | | | | |
| Comparative | G | A | ◯ | X | X |
| Example 8 | | | | | |
| Comparative | H | A | ◯ | X | ◯ |
| Example 9 | | | | | |

TABLE 4

| | | | | | | | | | High-temperature |
|---|---|---|---|---|---|---|---|---|---|
| | Ink Set | | | | | Intercolor | | | Storage |
| | Ink 1 | Ink 2 | Ink 3 | Ink 4 | Treating Liquid | Bleeding | Bleeding | Drying Time | stability |
| Example 9 | A | C | D | E | A | ◯ | ◯ | ◯ | ◯ |

From the results enumerated in the above Tables, it is found that when an ink containing two or more types of surfactants in specific conditions is used, its high-temperature storage stability is improved. Moreover, it is found that bleeding, intercolor bleeding, drying time, and high-temperature storage stability are satisfiable at the same time.

What is claimed is:

1. An inkjet ink comprising at least a pigment, a water-soluble solvent, at least two types of surfactant, and water, wherein:
(I) at least one type of nonionic surfactant, and at least one of an anionic surfactant and/or an amphoteric surfactant are contained as the surfactants;
(II) the nonionic surfactant has a weight-average molecular weight of 1000 or less and an SP value of 9.2 to 13, and the total number of carbon atoms and oxygen atoms in a unit constituting a hydrophilic group portion is 10 or more in the nonionic surfactant; and
(III) the at least one of an anionic surfactant and/or an amphoteric surfactant has a weight-average molecular weight of from 175 to 1500.

2. The inkjet ink of claim 1, wherein:
the anionic surfactant is selected from the group consisting of a dialkylsulfosuccinic acid, an alkenylsuccinic acid, an alkenylsulfosuccinic acid, a polyoxyalkylenealkyl ether phosphate, a polyoxyalkylenealkyl ether sulfate, and derivatives thereof; and
the amphoteric surfactant is selected from the group consisting of a betaine type surfactant, an amideamine oxide type surfactant, an imidazoline type surfactant, an alanine type surfactant, and derivatives thereof.

3. The inkjet ink of claim 1, wherein:
the ink has a ζ potential of from −60 mV to −10 mV.

4. The inkjet ink of claim 1, wherein:
the mass ratio of the addition amount of the nonionic surfactant to the addition amount of the at least one of an anionic surfactant and/or an amphoteric surfactant is within a range of from 1:0.01 to 1:0.75.

5. The inkjet ink of claim 1, wherein:
in the nonionic surfactant, the total number of carbon atoms and oxygen atoms in the unit constituting the hydrophilic group portion is 70 or less.

6. The inkjet ink of claim 1, wherein:
the clouding point in an aqueous solution of the nonionic surfactant is from 30° C. to 90° C.

7. An inkjet ink set, comprising:
the inkjet ink of claim 1; and
a treating liquid containing at least a flocculant.

8. The inkjet ink set of claim 7, wherein:
the inkjet ink further comprises a surfactant having a weight-average molecular weight of 2000 or more as the surfactant.

9. The inkjet ink set of claim 7, wherein:
the treating liquid further contains at least one colorant selected from the group consisting of a dye, a pigment having a sulfonic acid or a sulfonate on the surface thereof, and a self-dispersible pigment.

10. An inkjet ink tank, comprising:
the inkjet ink of claim 1 stored therein.

11. An inkjet ink tank, comprising:
the inkjet ink set of claim 7 stored therein.

12. An inkjet recording method, comprising:
ejecting the inkjet ink of claim 1 onto a recording medium to form a picture image.

13. An inkjet recording method, comprising:
ejecting the ink and the treating liquid of the inkjet ink set of claim 7 onto a recording medium to form a picture image.

14. The inkjet recording method of claim 12, wherein:
an ink supplied from an inkjet ink tank storing the inkjet ink is ejected onto the recording medium.

15. The inkjet recording method of claim 13, wherein:
an ink and a treating liquid supplied from an inkjet ink tank storing the inkjet ink set are ejected onto the recording medium.

16. An inkjet recording apparatus, comprising:
a recording head for ejecting the inkjet ink of claim 1 onto a recording medium.

17. An inkjet recording apparatus, comprising:
a recording head for ejecting the ink and the treating liquid of the inkjet ink set of claim 7 onto a recording medium.

18. The inkjet recording apparatus of claim 17, wherein:
the ink and the treating liquid are ejected onto the recording medium in an amount of 25 ng or less per one drop.

19. The inkjet recording apparatus of claim 17, wherein:
the ink and the treating liquid are ejected on the recording medium with a mass ratio of from 1:10 to 10:1.
